(19) United States
(12) Patent Application Publication
(10) Pub. No.: US 2015/0212399 A1
(43) Pub. Date: Jul. 30, 2015

(54) TEMPERATURE DETECTOR AND PROJECTOR USING THE TEMPERATURE DETECTOR

(71) Applicants: Ming-Cheng Lin, Hsin-Chu (TW); Chia-Ming Chen, Hsin-Chu (TW)

(72) Inventors: Ming-Cheng Lin, Hsin-Chu (TW); Chia-Ming Chen, Hsin-Chu (TW)

(73) Assignee: Coretronic Corporation, Hsin-Chu (TW)

(21) Appl. No.: 14/519,155

(22) Filed: Oct. 21, 2014

(30) Foreign Application Priority Data
Jan. 29, 2014 (CN) 201410043644.9

(51) Int. Cl. G03B 21/16; G01K 13/00; G03B 21/20

(52) U.S. Cl. CPC G03B 21/16; G03B 21/206; G01K 13/00

(57) ABSTRACT

A temperature detector and a projector using the temperature detector are provided. The temperature detector is configured to judge the operating temperature of the lamp in the projector. The temperature detector includes a charging/discharging circuit and a temperature judgment unit. The charging/discharging circuit receives a system voltage and provides a temperature voltage. The temperature judgment unit receives the temperature voltage and judges whether or not the operating temperature of the lamp falls in a first temperature range according to the temperature voltage so as to correspondingly output a temperature judgment signal. The scheme of using the temperature detector can determine a heat-dissipation time required by the lamp to advance the accomplishment rate of re-lighting and avoid affecting the lifetime of the lamp due to frequent lighting operation.

### CROSS-REFERENCE TO RELATED APPLICATION

This application claims the priority benefit of Chinese application serial no. 201410043644.9, filed on Jan. 29, 2014. The entirety of the above-mentioned patent application is hereby incorporated by reference herein and made a part of this specification.

### BACKGROUND OF THE INVENTION

1. Field of the Invention

The invention generally relates to a detector, and more particularly, to a temperature detector and a projector using the temperature detector.

2. Description of Related Art

Today, the light source of a projector is roughly divided into lamp, light-emitting diode (LED) and laser, wherein the lamp has advantage of low cost and high luminance so that the most projectors still use the lamp as the light source.

For a projector using a lamp, in order to make a secondary lighting operation, because the operating temperature of the lamp after using is still too high, so that the mercury inside the lump becomes vaporized mercury, and it is not easy to accomplish the secondary lighting operation. The most common method to solve the problem is to re-try. At the time, a fan is used to cool the lamp whenever need. After the fan is turned on for a fixed duration (such as 20-25 seconds), the lamp is turned on immediately. Once the lamp fails to be lit up, the fan immediately cools the lamp again. According to the above depiction, the lamp is unable to be lit up and the following lighting operation is needed, and the frequent lightning operation would affect the lifetime of the lamp.

U.S. Pat. No. 6,979,086 discloses a projector using a lamp as the light source thereof, wherein an image processing system produces a projection image based on a video signal. The central processing unit (CPU) of the projector controls the aforementioned image processing system. A plurality of cooling fans are disposed at least close to the power supply, the lamp or the image processing system to reduce the temperature around the cooling fans, and a pulse signal corresponding to the speed of the cooling fan is generated. After that, a charging circuit thereof generates a continuous charging signal and a protection start signal to reset the CPU, turn off the power supply or turn off the lamp.

US Patent Application No. 20070096669 discloses a device and a method for controlling the fan speed, wherein a comparator detects the analog signal of driving the fan. When the analog signal is abnormal through detecting, a voltage generating circuit generates a specific voltage to maintain a minimum operating voltage for the fan. When the analog signal becomes normal, a protection circuit is used to make the fan driven by the analog signal through receiving a signal provided by the system equipped with the fan.

### SUMMARY OF THE INVENTION

Accordingly, the present invention is directed to a temperature detector capable of detecting the temperature range where the present operating temperatures of the lamp belong to after the lamp finishes a first lighting operation.

The invention is also directed to a projector using the temperature detector and able to determine the heat-dissipation time required by the lamp according to the temperature range where the present operating temperatures of the lamp belong to so as to increase the accomplishment rate of re-lighting and avoid affecting the lifetime of the lamp due to frequent lighting operation.

Other advantages of the invention should be further indicated by the disclosures of the invention, and omitted herein for simplicity.

To achieve one of, a part of or all of the above-mentioned objectives, or to achieve other objectives, an embodiment of the invention provides a temperature detector configured to judge the operating temperature of the lamp in the projector. The temperature detector includes a charging and discharging circuit and a temperature judgment unit. The charging and discharging circuit receives a system voltage and provides a temperature voltage. The temperature judgment unit receives the temperature voltage and judges whether or not the operating temperature falls in a first temperature range according to the temperature voltage so as to correspondingly output a temperature judgment signal.

To achieve one of, a part of or all of the above-mentioned objectives, or to achieve other objectives, an embodiment of the present invention provides a projector, which includes a lamp, a fan, a driving circuit and an aforementioned temperature detector. The fan is configured to dissipate heat generated from the lamp. The temperature detector is for judging the operating temperature and providing a temperature judgment signal. The driving circuit is coupled to the lamp and the fan and receives the temperature judgment signal. When the lamp is turned on again, it determines the heat-dissipation time of the fan for cooling the lamp according to the temperature judgment signal, wherein the driving circuit does not turn on the lamp during the heat-dissipation time.

Based on the depiction above, the temperature detector in the embodiments of the invention can detect the present operating temperature of the lamp after finishing the first lighting operation of the lamp. The projector in the embodiments of the invention can decide how long the running time of the fan to dissipate the heat from the lamp is needed for the next time of the lighting operation according to the temperature judgment signal so as to advance the accomplishment rate of re-lighting and avoid affecting the lifetime of the lamp due to frequent lighting operation.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic system diagram of a projector according to an embodiment of the invention.

FIG. 1B is a chart diagram showing the operating temperatures of the lamp according to an embodiment of the invention.

FIG. 2 is a schematic system diagram of a temperature detector according to an embodiment of the invention.

FIG. 3 is a schematic circuit diagram of a temperature detector according to an embodiment of the invention.

FIG. 4 is a schematic circuit diagram of a temperature detector according to another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

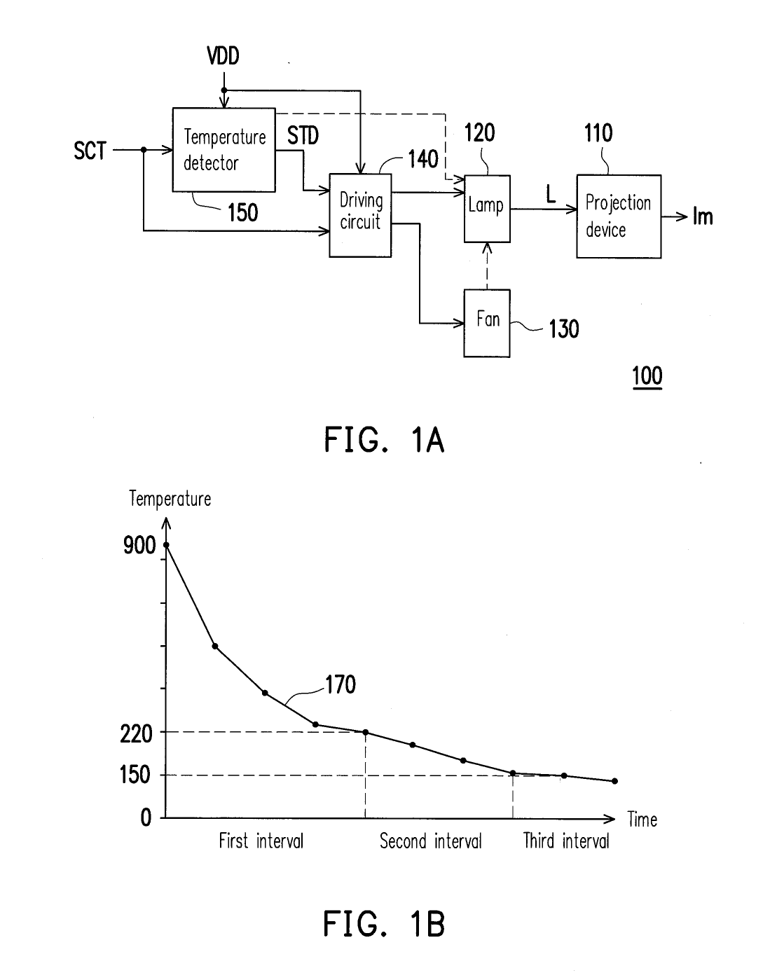

FIG. 1A is a schematic system diagram of a projector according to an embodiment of the invention. Referring to FIG. 1A, in the embodiment, a projector 100 includes a projection device 110, a lamp 120, a fan 130, a driving circuit 140 and a temperature detector 150. The lamp 120 provides a light beam L. The projection device 110 can be seen as an optical component or a set of optical components, and transmits the light beam L to project an image Im. The fan 130 is provided for dissipating the heat generated from the lamp 120. The temperature detector 150 receives a control signal SCT and a system voltage VDD and judges the operating temperature of the lamp 120. The temperature detector 150 gets charged from the system voltage VDD and provides a temperature judgment signal STD according to the control signal SCT so as to indicate whether or not the operating temperature of the lamp falls in a specific temperature range (such as 900° C.-220° C. or 220° C.-150° C.). In the embodiment, the control signal SCT is used to represent whether or not the lamp 120 is lit up, i.e., the control signal SCT is enabled when the lamp 120 to be lit up.

The driving circuit 140 receives the system voltage VDD and is coupled to the lamp 120 and the fan 130, such that the driving circuit 140 controls whether to turn on the lamp 120 and controls whether the fan 130 dissipates the heat generated from the lamp 120. The driving circuit 140 is coupled to the temperature detector 150 to receive the temperature judgment signal STD. When the lamp 120 is lit up again (i.e., turned on again), the driving circuit 140 determines the heat-dissipation time of the fan 130 for cooling the lamp 120 according to the temperature judgment signal STD, wherein different temperature ranges correspond to different heat-dissipation time, and the aforementioned heat-dissipation time is sufficient to reduce the temperature of the lamp 120 to be less than or equal to the temperature able to light up the lamp 120. During the heat-dissipation time, i.e. during the time that the fan 130 is turned on, the driving circuit 140 does not turn on the lamp 120; after the heat-dissipation time, the driving circuit 140 can turn on the lamp 120.

Accordingly, when the user wants to use the projector 100 again (i.e., wants the lamp 120 is lit up again), the driving circuit 140 judges whether or not the lamp 120 can be immediately lit up according to the temperature judgment signal STD; if the lamp 120 can not be lit up immediately, the fan 130 dissipates the heat of the lamp 120. When the operating temperature of the lamp 120 is reduced to be less than or equal to the temperature able to light up the lamp 120, the driving circuit 140 can turn on the lamp 120. Therefore, the projector 100 determines the heat-dissipation time of the fan 130 for cooling the lamp 120 according to the present operating temperature of the lamp 120 so as to increase the accomplishment rate of re-lighting and avoid affecting the lifetime of the lamp 120 due to frequent lighting operation.

FIG. 1B is a chart diagram showing the operating temperatures of the lamp according to an embodiment of the invention. Referring to FIGS. 1A and 1B, in the embodiment, the lamp 120 can be assumed to be lit up for 40 minutes already. After the lamp 120 is extinguished, the operating temperatures of the lamp 120 are shown by the curve 170, in which the temperature of the lamp 120 keeps reduced along with the extinguished time of the lamp 120. In the embodiment, the operating temperatures of the lamp 120 is divided into three intervals (i.e., three temperature ranges): for example, 900° C.-220° C. (first interval), 220° C.-150° C. (second interval) and below 150° C. (third interval). The heat-dissipation time (for example, 40 seconds) corresponding to the first interval is greater than the heat-dissipation time (for example, 20 seconds) corresponding to the second interval, the heat-dissipation time corresponding to the second interval is greater than the heat-dissipation time (for example, 0 second) corresponding to the third interval, and the higher the operating temperature for the lamp 120 to be lit up again, the longer the required heat-dissipation time for cooling the lamp 120 is (i.e., the running time of the fan 130 is longer).

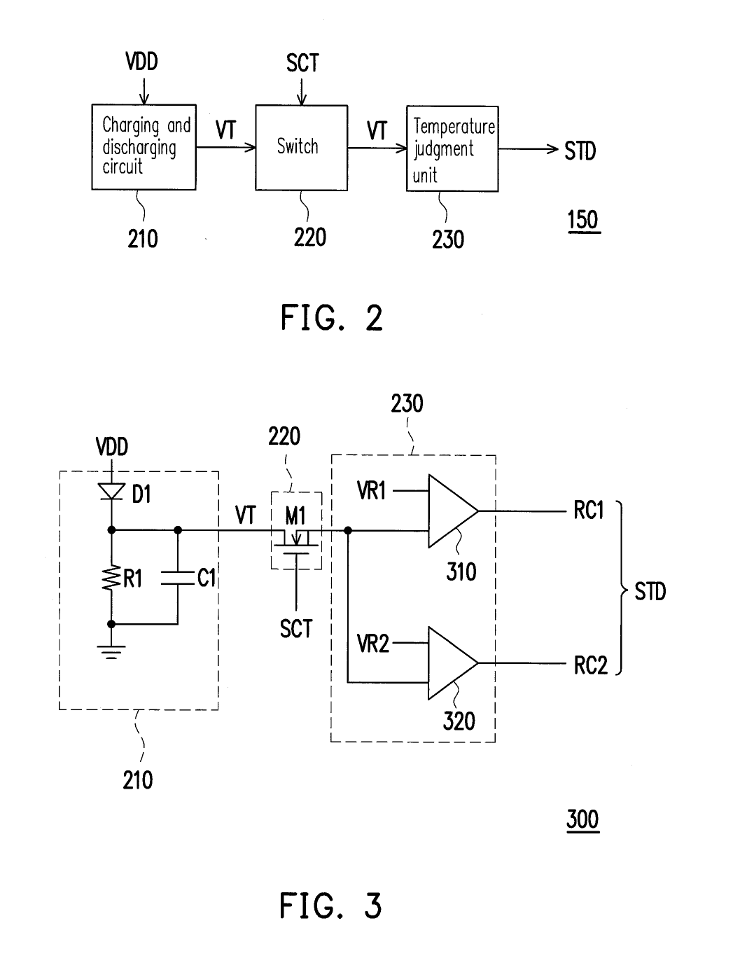

FIG. 2 is a schematic system diagram of a temperature detector according to an embodiment of the invention. Referring to FIGS. 1A and 2, the same or similar parts herein are marked with the same or similar notations. In the embodiment, the temperature detector 150 includes a charging and discharging circuit 210, a switch 220 and a temperature judgment unit 230. The charging and discharging circuit 210 receives the system voltage VDD for charging and provides a temperature voltage VT according to the operating temperature of the lamp 120. The switch 220 is coupled to the charging and discharging circuit 210 and the temperature judgment unit 230, receives the control signal SCT and determines whether or not to provide temperature voltage VT to the temperature judgment unit 230 according to the control signal SCT. When the temperature judgment unit 230 receives the temperature voltage VT, the temperature judgment unit 230 will judge whether or not the operating temperature of the lamp 120 falls in a temperature range according to the temperature voltage VT so as to correspondingly output a temperature judgement signal STD.

FIG. 3 is a schematic circuit diagram of a temperature detector according to an embodiment of the invention. Referring to FIGS. 2 and 3, in which the same or similar parts herein are marked with the same or similar notations. In a temperature detector 300 of the embodiment, the charging and discharging circuit 210 includes a diode D1, a capacitor C1 and a resistor R1. An anode of the diode D1 receives the system voltage VDD to prevent the reverse voltage, the capacitor C1 is coupled between a cathode of the diode D1 and a ground voltage end for charging according to the system voltage VDD, and the resistor R1 is coupled in series between the cathode of the diode D1 and the ground voltage end. The drop rate represented by the curve 170 is the same as the capacitance of the capacitor C1 and the impedance value of the resistor R1, which can be set by anyone skilled in the art and the embodiment of the invention is not limited to.

The switch 220 includes a transistor M1, wherein the drain of the transistor M1 is coupled to the charging and discharging circuit 210 to receive the temperature voltage VT, and the gate of the transistor M1 receives the control signal SCT and the source of the transistor M1 is coupled to the temperature judgment unit 230.

The temperature judgment unit 230 includes two comparators 310 and 320. The comparators 310 and 320 can be a common comparator or a hysteresis comparator, which the embodiment of the invention is not limited to. The comparator 310 is provided for comparing the temperature voltage VT with the first reference voltage VR1 to generate a comparison result RC1. The comparator 320 is provided for comparing the temperature voltage VT with the second reference voltage VR2 to generate a comparison result RC2, wherein the first reference voltage VR1 is different from the second reference voltage VR2, and the temperature judgment signal STD is the parameters corresponding to the comparison result RC1 of the comparator 310 and the comparison result RC2 of the comparator 320. For example, if the comparator 310 is in charge of judging whether or not the operating temperature of the lamp 120 is greater than 220° C., the first reference voltage VR1 can correspond to 220° C.; if the comparator 320 is in charge of judging whether or not the operating temperature of the lamp 120 is greater than 150° C., the second reference voltage VR2 can correspond to 150° C. Since the operating temperature of the lamp 120 keeps being reduced along with the extinguished time of the lamp 120, for the above-mentioned embodiment, the first reference voltage VR1 (for example, 2.2 V) would be greater than the second reference voltage VR2 (for example, 1.1 V).

In the aforementioned embodiment, each of the comparators 310 and 320 has a higher input impedance so that the discharging of the charging and discharging circuit 210 does not be affected, and the operating temperature can be judged without considering the effect of the switch 220. In addition, in some embodiments, the temperature judgment unit 230 is designed for judging two intervals and the number of the comparators (for example, 310 and 320) is changed to one, which can be decided by anyone skilled in the art and the embodiment of the invention is not limited to.

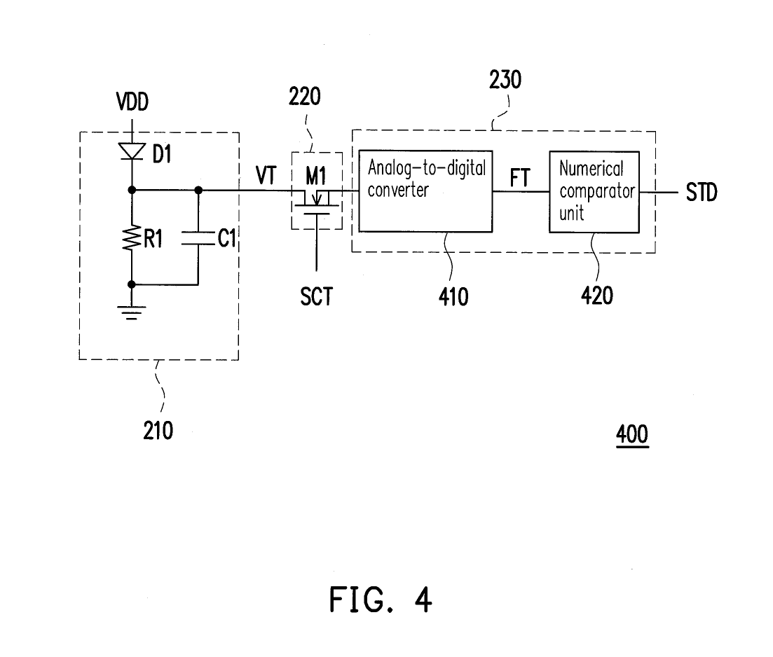

FIG. 4 is a schematic circuit diagram of a temperature detector according to another embodiment of the invention. Referring to FIGS. 2-4, the same or similar parts herein are marked with the same or similar notations. In the temperature detector 400 of the embodiment, the temperature judgment unit 230 includes an analog-to-digital converter 410 and a numerical comparator unit 420. The analog-to-digital converter 410 receives the temperature voltage VT from the charging and discharging circuit 210 and converts the analog temperature voltage VT into a digital signal, followed by providing a temperature signal FT. The numerical comparator unit 420 receives the temperature signal FT to determine whether the operating temperature of the lamp 120 falls in a certain temperature range and accordingly outputs a temperature judgment signal STD. The temperature judgment unit 230 employing the analog-to-digital converter 410 and the numerical comparator unit 420 is able to make the heat-dissipation time of the fan 130 divided more fine for judgment.

In summary, the temperature detector in the embodiments of the invention can detect the present operating temperature of the lamp and provide a temperature judgment signal after finishing the first lighting operation of the lamp. The projector in the embodiments of the invention can decide how long the running time of the fan to dissipate the heat from the lamp is needed for the next time of the lighting operation according to the temperature judgment signal so as to advance the accomplishment rate of re-lighting and avoid affecting the lifetime of the lamp due to frequent lighting operation.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A temperature detector, configured to judge an operating temperature of a lamp of a projector and comprising a charging and discharging circuit and a temperature judgment unit, wherein the charging and discharging circuit receives a system voltage and provides a temperature voltage; and the temperature judgment unit receives the temperature voltage and judges whether or not the operating temperature of the lamp falls in a first temperature range according to the temperature voltage so as to correspondingly output a temperature judgment signal.

2. The temperature detector as claimed in claim 1, wherein the charging and discharging circuit comprises:
a diode, wherein an anode of the diode receives the system voltage;
a capacitor, coupled between a cathode of the diode and a ground voltage end; and
a resistor, coupled between the cathode of the diode and the ground voltage end.

3. The temperature detector as claimed in claim 1, wherein the temperature judgment unit comprises:
an analog-to-digital converter, receiving the temperature voltage and providing a temperature signal; and
a numerical comparator unit, receiving the temperature signal to judge whether or not the operating temperature of the lamp falls in the first temperature range so as to correspondingly output the temperature judgment signal.

4. The temperature detector as claimed in claim 1, wherein the temperature judgment unit comprises:
a first comparator for comparing the temperature voltage with a first reference voltage and outputting the temperature judgment signal according to a comparison result.

5. The temperature detector as claimed in claim 1, wherein the temperature judgment unit further judges whether or not the operating temperature of the lamp falls in a second temperature range according to the temperature voltage so as to correspondingly output the temperature judgment signal, wherein the second temperature range is different from the first temperature range.

6. The temperature detector as claimed in claim 5, wherein the temperature judgment unit comprises:
a second comparator for comparing the temperature voltage with a second reference voltage; and
a third comparator for comparing the temperature voltage with a third reference voltage, wherein the temperature judgment signal corresponds to the comparison results of the second comparator and the third comparator.

7. The temperature detector as claimed in claim 1, further comprising a switch for receiving a control signal and transmitting the temperature voltage to the temperature judgment unit according to the control signal.

8. The temperature detector as claimed in claim 7, wherein the temperature detector enables the control signal when the lamp is turned on again.

9. A projector, comprising a lamp, a fan, a temperature detector and a driving circuit, wherein the fan is configured to dissipate heat generated from the lamp; the temperature detector is for judging operating temperature of the lamp and providing a temperature judgment signal; the driving circuit is coupled to the lamp and the fan for receiving the temperature judgment signal, and the driving circuit determines a heat-dissipation time of the fan for cooling the lamp according to the temperature judgment signal when the lamp is turned on again, wherein the driving circuit does not turn on the lamp during the heat-dissipation time.

10. The projector as claimed in claim 9, wherein the temperature detector comprises:
a charging and discharging circuit, for receiving a system voltage and providing a temperature voltage; and
a temperature judgment unit, for receiving the temperature voltage and judging whether or not the operating temperature of the lamp falls in a first temperature range according to the temperature voltage so as to correspondingly output a temperature judgment signal.

11. The projector as claimed in claim 10, wherein the charging and discharging circuit comprises:
a diode, wherein an anode of the diode receives the system voltage;
a capacitor, coupled between a cathode of the diode and a ground voltage end; and
a resistor, coupled between the cathode of the diode and the ground voltage end.

12. The projector as claimed in claim 10, wherein the temperature judgment unit comprises:
an analog-to-digital converter, receiving the temperature voltage and providing a temperature signal; and
a numerical comparator unit, receiving the temperature signal to judge whether or not the operating temperature of the lamp falls in the first temperature range so as to correspondingly output the temperature judgment signal.

13. The projector as claimed in claim 10, wherein the temperature judgment unit comprises:
a first comparator for comparing the temperature voltage with a first reference voltage and outputting the temperature judgment signal according to a comparison result.

14. The projector as claimed in claim 10, wherein the temperature judgment unit further judges whether or not the operating temperature of the lamp falls in a second temperature range according to the temperature voltage so as to correspondingly output the temperature judgment signal, wherein the second temperature range is different from the first temperature range.

15. The projector as claimed in claim 14, wherein the temperature judgment unit comprises:
a second comparator for comparing the temperature voltage with a second reference voltage; and
a third comparator for comparing the temperature voltage with a third reference voltage, wherein the temperature judgment signal corresponds to the comparison results of the second comparator and the third comparator.

16. The temperature detector as claimed in claim 10, further comprising a switch for receiving a control signal and transmitting the temperature voltage to the temperature judgment unit according to the control signal.

17. The temperature detector as claimed in claim 16, wherein the projector enables the control signal when the lamp is turned on again.
